(19) United States
(12) Patent Application Publication
(10) Pub. No.: US 2025/0283973 A1
(43) Pub. Date: Sep. 11, 2025

(54) SOUND SOURCE POSITION DETERMINATION METHOD, HEAD-MOUNTED DEVICE, AND STORAGE MEDIUM

(71) Applicant: GOERTEK INC., Weifang, Shandong (CN)

(72) Inventors: Jian LI, Weifang, Shandong (CN); Qiang CHEN, Weifang, Shandong (CN); Xiaoqiong JIN, Weifang, Shandong (CN); Nihong GUO, Weifang, Shandong (CN); Dandan FENG, Weifang, Shandong (CN); Fangfang ZHANG, Weifang, Shandong (CN); Xiao BAO, Weifang, Shandong (CN); Ziwei TONG, Weifang, Shandong (CN)

(21) Appl. No.: 18/858,967

(22) PCT Filed: Jul. 5, 2022
(86) PCT No.: PCT/CN2022/103889

§ 371 Date: Oct. 22, 2024

(30) Foreign Application Priority Data
May 25, 2022 (CN) 202210575064.9

(51) Int. Cl. G01S 5/22; H04S 7/00

(52) U.S. Cl. CPC G01S 5/22; H04S 7/303

(57) ABSTRACT

Some embodiments of the disclosure disclose a sound source position determination method, a device and a storage medium. The method is applied to a head-mounted device including at least four microphones. The method includes: determining microphone coordinates of the microphones in a space coordinate system according to a device coordinate of a preset sound source device; determining time differences between receiving time points at which the microphones receive audio signals sent by a sound source to be positioned; determining a sound source coordinate of the sound source to be positioned in the space coordinate system according to the microphone coordinates and the time differences. According to the disclosure, a sound source position emitting sound can be accurately calculated by the head-mounted device, so that a user can clearly know the specific position of the sound source emitting the sound in a reality space environment when wearing the head-mounted device.

The present disclosure claims the priority to the Chinese Patent Application No. 202210575064.9, entitled “SOUND SOURCE POSITION DETERMINATION METHOD, DEVICE, AND STORAGE MEDIUM” filed with China Patent Office on May 25, 2022, the entire contents of which are incorporated into the present disclosure by reference.

### TECHNICAL FIELD

The present disclosure relates to a technical field of virtual reality technology, and in particular to a sound source position determination method, a device, and a storage medium.

### DESCRIPTION OF RELATED ART

Virtual Reality technology, hereinafter referred to as VR technology, uses computers or other intelligent computing devices to simulate a three-dimensional virtual world, which provide users with simulations of senses such as vision, hearing, and touch, making people feel as if they are in the scene. Currently, different head-mounted devices (such as VR devices) have been developed in the market based on VR technology, and users can experience virtual reality scenes by using the head-mounted devices. When presenting the virtual reality scene, the current head-mounted devices are unable to accurately present the position of a sound source of a reality environment in the virtual reality scenes, reducing the user's experience of sound of real-world in the virtual reality scenes.

### SUMMARY

The embodiments of the present disclosure provide a sound source position determination method, a device, and a storage medium, aiming to solve the technical problem that the current head-mounted devices are unable to accurately present the position of the sound source of the reality environment in the virtual reality scenes, reducing the user's experience of the sound of the real-world in the virtual reality scenes.

The present disclosure provides a sound source position determination method, which is applied to a head-mounted device, wherein the head-mounted device includes at least four microphones. The sound source position determination method includes:
determining microphone coordinates of the microphones in a space coordinate system according to a device coordinate of a preset sound source device, wherein the space coordinate system is established in a space where the head-mounted device is located;
determining time differences between receiving time points at which the microphones receive audio signals sent by a sound source to be positioned; and
determining a sound source coordinate of the sound source to be positioned in the space coordinate system according to the microphone coordinates and the time differences.

In an embodiment, the preset sound source device includes at least four loudspeakers disposed on the head-mounted device, and the determining the microphone coordinates of the microphones in the space coordinate system according to the device coordinate of the preset sound source device includes:
determining device coordinates of the loudspeakers respectively;
controlling the loudspeakers to emit first calibration audio signals respectively;
determining first calibration time differences between first calibration receiving time points at which the microphones receive the first calibration audio signals respectively; and
determining the microphone coordinates according to the first calibration time differences and the device coordinates.

In an embodiment, the determining the device coordinates of the loudspeakers respectively includes:
establishing the space coordinate system based on the microphones, and obtaining initial microphone coordinates of the microphones in the space coordinate system respectively;
controlling the loudspeakers to emit second calibration audio signals respectively, and determining second calibration time differences between second calibration receiving time points at which the microphones receive the second calibration audio signals respectively; and
determining the device coordinates of the loudspeakers respectively according to the second calibration time differences and the initial microphone coordinates.

In an embodiment, the controlling the loudspeakers to emit the first calibration audio signal respectively includes:
establishing a motion coordinate system based on a center of the head-mounted device; and
controlling a loudspeaker located on a coordinate axis of the motion coordinate system and a loudspeaker located outside a coordinate axis plane to emit the first calibration audio signals.

In an embodiment, the determining the sound source coordinate of the sound source to be positioned in the space coordinate system according to the microphone coordinates and the time differences includes:
setting a minimum flying time in which the audio signals reach one of the microphones;
constructing equations according to a sound transmission speed, the minimum flying time, the microphone coordinates and the time differences; and
determining the sound source coordinate of the sound source to be positioned in the space coordinate system according to solution results of the equations.

In an embodiment, the method further includes: after the determining the sound source coordinate of the sound source to be positioned in the space coordinate system according to the microphone coordinates and the time differences,
determining a relative position coordinate of the sound source to be positioned with respect to the head-mounted device according to the sound source coordinates and the microphone coordinates;
determining play parameters corresponding to the audio signals according to the relative position coordinate, and playing the audio signals based on the play parameters; and/or
indicating a position where the sound source to be positioned is located in a reality environment image displayed by the head-mounted device according to the relative position coordinate.

In an embodiment, the preset sound source device includes at least one loudspeaker disposed on the head-mounted device, and the determining the microphone coordinates of the microphones in the space coordinate system according to the device coordinate of the preset sound source device further includes:
establishing the space coordinate system based on the microphones, and obtaining initial microphone coordinates of the microphones in the space coordinate system respectively;
controlling the loudspeaker to emit a third calibration audio signal, and determining third calibration time differences between third calibration receiving time points at which the microphones receive the third calibration audio signal;
determining a device coordinate of the loudspeaker according to the third calibration time differences and the initial microphone coordinates, and controlling the loudspeaker to emit a fourth calibration audio signal; and
determining a fourth calibration time difference of a fourth calibration receiving time point at which each of the loudspeakers receives the fourth calibration audio signal, and determining the microphone coordinate according to the fourth calibration time difference and the device coordinates.

In an embodiment, the preset sound source device includes at least one loudspeaker with device coordinates which are known previously, and the determining the microphone coordinates of the microphones in the space coordinate system according to the device coordinate of the preset sound source device further includes:
obtaining device coordinates of the loudspeakers respectively;
controlling the loudspeakers to emit calibration audio signals respectively;
determining calibration time differences between calibration receiving time points at which the microphones receive the calibration audio signals respectively; and
determining the microphone coordinates according to the calibration time differences and the device coordinates.

In addition, to achieve the above-mentioned purpose, the present disclosure also provides a head-mounted device, including: a memory, a processor, and a sound source position determination program stored in the memory and executable on the processor, wherein the sound source position determination program, when executed by the processor, implements steps of the above-mentioned sound source position determination method.

In addition, to achieve the above-mentioned purpose, the present disclosure also provides a storage medium, on which a sound source position determination program is stored, wherein when the sound source position determination program is executed by a processor, steps of the above-mentioned sound source position determination method are implemented.

The technical solutions provided by the sound source position determination method, the device and the storage medium in the embodiments of the present disclosure has at least the following technical effects or advantages:

The sound source position determination method is applied to the head-mounted device, and the head-mounted device includes at least four microphones. The sound source position determination method comprises: determining microphone coordinates of the microphones in a space coordinate system according to a device coordinate of a preset sound source device; determining time differences between receiving time points at which the microphones receive audio signals sent by a sound source to be positioned; and determining a sound source coordinate of the sound source to be positioned in the space coordinate system according to the microphone coordinates and the time differences. The technical solution solves the technical problem that the current head-mounted devices are unable to accurately present the position of the sound source of the reality environment in the virtual reality scenes, reducing the user's experience of the sound of the real-world in the virtual reality scenes. According to the present disclosure, the sound source position emitting sound can be accurately calculated by the head-mounted device, so that the user can clearly know the specific position of the sound source emitting the sound in the reality space environment when wearing the head-mounted device.

### BRIEF DESCRIPTION OF DRAWINGS

In order to more clearly illustrate the technical solutions in the embodiments of the present disclosure or the prior art, the drawings required to be used for the content of the embodiments or the prior art will be briefly introduced in the following. Obviously, the drawings in the following description are merely a part of the drawings of the present disclosure, and for those of ordinary skill in the art, other drawings can also be obtained from the provided drawings without any creative effort.

FIG. 1 is a structural schematic diagram of hardware operating environment involved in an embodiment of the present disclosure;

FIG. 2 is a flow chart of an embodiment of a sound source position determination method of the present disclosure;

FIG. 3 is a schematic diagram showing a positional relationship between the head-mounted device and a space coordinate system according to the present disclosure;

FIG. 4 is a schematic diagram of a sound source to be positioned and a head-mounted device in the present disclosure;

FIG. 5 is a schematic diagram showing a positional relationship between microphones, loudspeakers and a space coordinate system according to the present disclosure; and

FIG. 6 is a flow chart showing the process after step S230 of the sound source position determination method of the present disclosure.

### DETAILED DESCRIPTIONS

Technical solutions of embodiments of the present disclosure will be described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

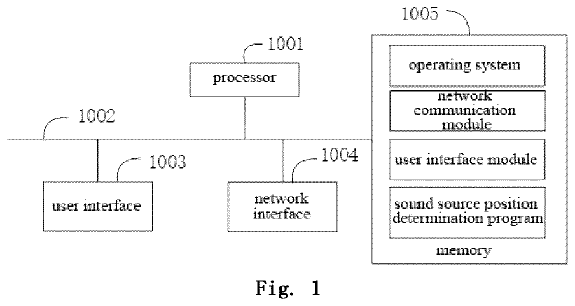

As illustrated in FIG. 1, FIG. 1 is a structural schematic diagram of hardware operating environment involved in an embodiment of the present disclosure.

It should be noted that FIG. 1 may be a structural schematic diagram of hardware operating environment of a head-mounted device.

As illustrated in FIG. 1, the head-mounted device may include: a processor 1001 such as a CPU, a memory 1005, a user interface 1003, a network interface 1004, and a communication bus 1002. The communication bus 1002 is used to realize connection and communication between these components. The user interface 1003 may include a display screen (Display), an input unit such as a keyboard (Keyboard), and the optional user interface 1003 may also include a standard wired interface or a wireless interface. The network interface 1004 may optionally include a standard wired interface or a wireless interface (such as a WI-FI interface). The memory 1005 may be a high-speed RAM memory or a non-volatile memory, such as a disk memory. The memory 1005 may optionally be a storage device independent of the aforementioned processor 1001.

Those skilled in the art will appreciate that the head-mounted device structure shown in FIG. 1 does not constitute a limitation on the head-mounted device, and may include more or fewer components than that shown in FIG. 1, or certain components may be combined, or may be disposed by different components.

As illustrated in FIG. 1, the memory 1005, as a storage medium, may include an operating system, a network communication module, a user interface module, and a sound source position determination program. The operating system manages and controls the operation of programs of hardware and software resources of the head-mounted device, the sound source position determination program, and other software or programs.

In the head-mounted device shown in FIG. 1, the user interface 1003 is mainly used to connect with a terminal and communicate data with the terminal, the network interface 1004 is mainly used to communicate data with a background server, and the processor 1001 may be used to call a sound source position determination program stored in the memory 1005.

In the embodiment, the head-mounted device includes a memory 1005, a processor 1001, and a sound source position determination program stored in the memory 1005 and executable on the processor.

When the processor 1001 calls the sound source position determination program stored in the memory 1005, the following operations are performed:
determining microphone coordinates of the microphones in a space coordinate system according to a device coordinate of a preset sound source device, wherein the space coordinate system is established in a space where the head-mounted device is located;
determining time differences between receiving time points at which the microphones receive audio signals sent by a sound source to be positioned; and
determining a sound source coordinate of the sound source to be positioned in the space coordinate system according to the microphone coordinates and the time differences.

When the processor 1001 calls the sound source position determination program stored in the memory 1005, the following operations are further performed:
determining device coordinates of the loudspeakers respectively;
controlling the loudspeakers to emit first calibration audio signals respectively;
determining first calibration time differences between first calibration receiving time points at which the microphones receive the first calibration audio signals respectively; and
determining the microphone coordinates according to the first calibration time differences and the device coordinates.

When the processor 1001 calls the sound source position determination program stored in the memory 1005, the following operations are further performed:
establishing the space coordinate system based on the microphones, and obtaining initial microphone coordinates of the microphones in the space coordinate system respectively;
controlling the loudspeakers to emit second calibration audio signals respectively, and determining second calibration time differences between second calibration receiving time points at which the microphones receive the second calibration audio signals respectively; and
determining the device coordinates of the loudspeakers respectively according to the second calibration time differences and the initial microphone coordinates.

When the processor 1001 calls the sound source position determination program stored in the memory 1005, the following operations are further performed:
establishing a motion coordinate system based on a center of the head-mounted device; and
controlling a loudspeaker located on a coordinate axis of the motion coordinate system and a loudspeaker located outside a coordinate axis plane to emit the first calibration audio signals.

When the processor 1001 calls the sound source position determination program stored in the memory 1005, the following operations are further performed:
setting a minimum flying time in which the audio signals reach one of the microphones;
constructing equations according to a sound transmission speed, the minimum flying time, the microphone coordinates and the time differences; and
determining the sound source coordinate of the sound source to be positioned in the space coordinate system according to solution results of the equations.

When the processor 1001 calls the sound source position determination program stored in the memory 1005, the following operations are further performed:
determining a relative position coordinate of the sound source to be positioned with respect to the head-mounted device according to the sound source coordinates and the microphone coordinates;
determining play parameters corresponding to the audio signals according to the relative position coordinate, and playing the audio signals based on the play parameters; and/or
indicating a position where the sound source to be positioned is located in a reality environment image displayed by the head-mounted device according to the relative position coordinate.

When the processor 1001 calls the sound source position determination program stored in the memory 1005, the following operations are further performed:
establishing the space coordinate system based on the microphones, and obtaining initial microphone coordinates of the microphones in the space coordinate system respectively;
controlling the loudspeaker to emit a third calibration audio signal, and determining third calibration time differences between third calibration receiving time points at which the microphones receive the third calibration audio signal;
determining a device coordinate of each of the loudspeakers according to the third calibration time differences and the initial microphone coordinates, and controlling the loudspeaker to emit a fourth calibration audio signal; and
determining a fourth calibration time difference of a fourth calibration receiving time point at which each of the loudspeakers receives the fourth calibration audio signal, and determining the microphone coordinate according to the fourth calibration time difference and the device coordinates.

When the processor 1001 calls the sound source position determination program stored in the memory 1005, the following operations are further performed:
obtaining device coordinates of the loudspeakers respectively;
controlling the loudspeakers to emit calibration audio signals respectively;
determining calibration time differences between calibration receiving time points at which the microphones receive the calibration audio signals respectively; and
determining the microphone coordinates according to the calibration time differences and the device coordinates.

The embodiments of the present disclosure provide embodiments of the sound source position determination method. It should be noted that, although a logical order is shown in the flowchart, in some cases, the steps shown or described may be performed in an order different from that shown here.

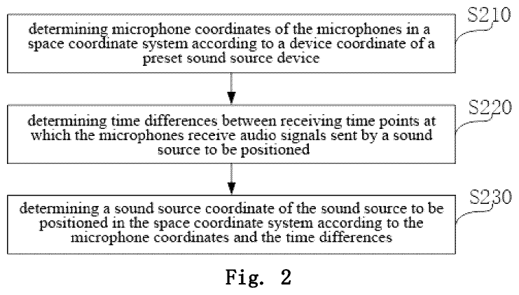

As illustrated in FIG. 2, in an embodiment of the present disclosure, the sound source position determination method of the present disclosure is applied to a head-mounted device, which includes at least four microphones, each microphone is arranged on the head-mounted device, and the position of a sound source that emits an audio signal in the reality environment can be located through the microphones. Here, this embodiment is illustrated using four microphones as an example. The sound source position determination method includes the following steps:

Step S210: determining microphone coordinates of the microphones in a space coordinate system according to a device coordinate of a preset sound source device.

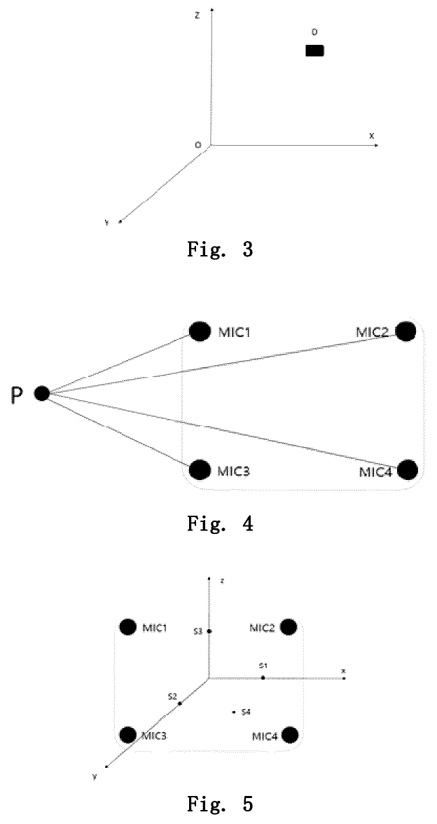

The preset sound source device is a device that can emit sound signals of different frequencies through control. In the embodiment, the sound signal emitted by the sound source device is referred to as a calibration audio signal. The preset sound source device may be disposed on the head-mounted device or may not be disposed on the head-mounted device. The device coordinate of the preset sound source device is a coordinate in a large coordinate system. When the preset sound source device is not disposed on the head-mounted device, the device coordinate is known; when the preset sound source device is disposed on the head-mounted device, the device coordinate is unknown. When the device coordinate is known, it can be directly obtained; and when the device coordinate is unknown, it can be obtained through calculation using initial microphone coordinates of the microphones in the space coordinate system. It will be understood that the space coordinate system is established in a space where the head-mounted device is located, the space coordinate system may also be called the geodetic coordinate system in the space where the head-mounted device is located, and the position of the head-mounted device is calibrated through the space coordinate system. As illustrated in FIG. 3, where D represents the head-mounted device. Assuming that any point is S on the head-mounted device, the initial position coordinate of S in the space coordinate system is (XS, YS, ZS). At least four MICs are disposed at the origin of the space coordinate system to receive a sound emitted from the head-mounted device, so that an absolute position of the point S on the head-mounted device in the space can be calculated by the coordinates of the at least four MICs. Here, the at least four MICs are specifically used to detect spatial position and posture of the head-mounted device.

After the user wears the head-mounted device, the spatial position and posture of the head-mounted device change with the movement of the user's head, accordingly, after the device coordinate of the preset sound source device is determined, microphone coordinates of the microphones in the space coordinate system can be determined according to the device coordinate of the preset sound source device.

Step S220: determining time differences between receiving time points at which the microphones receive audio signals sent by a sound source to be positioned.

Audio signals are emitted by a sound source to be positioned in the reality environment, the sound source to be positioned is something that can produce sound, for example, a person, an animal, a device that can play sound, etc., and the audio signal may be a human voice signal, a music audio signal, a car horn sound signal, a water sound signal, etc.

After the user wears and turns on the head-mounted device, each microphone is kept turned on in the head-mounted device, and each microphone detects the audio signal in the reality environment in real time. When each of the microphones receives the same audio signal, based on receiving time points at which the microphones receive the audio signal, time differences between the receiving time points at which the microphones receive the audio signal can be calculated, and the time differences can be used to represent time differences in flying time of the same audio signal from the sound source to be positioned to each microphone. For example, the receiving time point of the audio signal received by a microphone 1 is 8:10:11, the receiving time point of the audio signal received by a microphone 2 is 8:10:12, a time difference between the receiving time point of the audio signal received by the microphone 1 and the receiving time point of the audio signal received by the microphone 2 is 1 s, then the time difference in flying time of the audio signal from the sound source to be positioned to the microphone 1 and the microphone 2 is 1 s.

Step S230: determining a sound source coordinate of the sound source to be positioned in the space coordinate system according to the microphone coordinates and the time differences.

After obtaining the microphone coordinates and the time differences between the receiving time points, the microphone coordinates and the time differences between the receiving time points are known, and the sound source coordinate of the sound source to be positioned in the space coordinate system is unknown, then the sound source coordinate can be calculated based on a distance calculation principle between any two points in the space coordinate system.

Specifically, the Step S230 includes:
setting a minimum flying time in which the audio signals reach one of the microphones;
constructing equations according to a sound transmission speed, the minimum flying time, the microphone coordinates and the time differences; and
determining the sound source coordinate of the sound source to be positioned in the space coordinate system according to solution results of the equations.

As illustrated in FIG. 4, MIC1 to MIC4 represent four microphones disposed on the head-mounted device. When the number of the microphones is 4, distances between each microphone and the sound source to be positioned are MIC1P, MIC2P, MIC3P and MIC4P, respectively. Microphone coordinates of MIC1 to MIC4 are known and are expressed as MIC1 (x1, y1, z1), MIC2 (x2, y2, z2), MIC3 (x3, y3, z3), MIC4 (x4, y4, z4). P represents an unknown point, that is, a sound source to be positioned, the coordinate of the sound source to be positioned is unknown and is expressed as P (x0, y0, z0). Since x0, y0 and z0 are three variables, the flying time of the audio signal from the sound source to be positioned to each microphone is also unknown, that is, the flying time, x0, y0, z0 are variables that need to be solved. Specifically, since time differences between the receiving time points can be calculated, that is, are known values, it can be assumed that the flying time for the audio signal to reach any one of MIC1-MIC4 is the minimum flying time. For example, the flying time for the audio signal to reach MIC1 is the minimum flying time, so that equations can be constructed according to a sound transmission speed, the minimum flying time, the microphone coordinates of MIC1-MIC4 and the time differences. The equations are specifically as follows:

$$MIC 1 P 2 = ( Vair * Tmin ) 2 = ( x 1 - x 0 ) 2 + ( y 1 - y 0 ) 2 + ( z 1 - z 0 ) 2 ;$$

$$MIC 2 P 2 = ( Vair * ( Tmin + Δ t 2 ) ) 2 = ( x 2 - x 0 ) 2 + ( y 2 - y 0 ) 2 + ( z 2 - y 0 ) 2 ;$$

$$MIC 3 P 2 = ( Vair * ( Tmin + Δ t 3 ) ) 2 = ( x 3 - x 0 ) 2 + ( y 3 - y 0 ) 2 + ( z 3 - z 0 ) 2 ;$$

$$MIC 4 P 2 = ( Vair * ( Tmin + Δ t 4 ) ) 2 = ( x 4 - x 0 ) 2 + ( y 4 - y 0 ) 2 + ( z 4 - z 0 ) 2.$$

Here, since the transmission speed of the audio signal in air is the same as the transmission speed of the sound in air, Vair represents the sound transmission speed, Tmin represents the minimum flying time, Δt2 represents a time difference between the receiving time point of the audio signal received by MIC2 and the receiving time point of the audio signal received by MIC1, Δt3 represents a time difference between the receiving time point of the audio signal received by MIC3 and the receiving time point of the audio signal received by MIC1, and Δt4 represents a time difference between the receiving time point of the audio signal received by MIC4 and the receiving time point of the audio signal received by MIC1.

After constructing equations, Tmin, x0, y0 and z0, that is, the sound source coordinate P of the sound source to be positioned, is obtained by solving the equations. Assuming x0=1, y0=2 and z0=3, then P=(1,2,3).

According to the above technical solution, the embodiment accurately calculates the position of the sound source through the head-mounted device, so that the user can clearly know the specific position of the sound source emitting sound in the reality space environment when wearing the head-mounted device.

Optionally, the preset sound source device includes at least four loudspeakers disposed on the head-mounted device, that is, at least four loudspeakers are provided on the head-mounted device. This embodiment is illustrated using four loudspeakers as an example, and the four loudspeakers are S1, S2, S3 and S4. The Step S210 may include the following steps
determining device coordinates of the loudspeakers respectively;
controlling the loudspeakers to emit first calibration audio signals respectively;
determining first calibration time differences between first calibration receiving time points at which the microphones receive the first calibration audio signals respectively; and
determining the microphone coordinates according to the first calibration time differences and the device coordinates.

Specifically, the device coordinate of each of the loudspeakers needs to be calibrated in advance, that is, the device coordinate of each of the loudspeakers can be known. After obtaining the device coordinate of each of the loudspeakers, sounds are emitted through the loudspeakers to determine microphone coordinates of the microphones in the space coordinate system. It should be understood that the loudspeakers are controlled to emit sound signals with different frequencies from others, here, the sound signal is represented as a first calibration audio signal, and after the microphones receive the sound signals of different frequencies emitted by the loudspeaker respectively, first calibration receiving time points at which the microphones receive the first calibration audio signal respectively can be obtained, and accordingly, based on the first calibration receiving time points, first calibration time differences between the first calibration receiving time points can be calculated. Here, the purpose of controlling the loudspeakers to emit sound signals of different frequencies is to distinguish which loudspeaker emits the corresponding first calibration audio signal through the frequency of the first calibration audio signal, and the frequency of the first calibration audio signal is a sound frequency outside the audible range of the human ear, that is, when the user uses the head-mounted device, he or she cannot hear the sound emitted by the loudspeaker, which can avoid causing noise to the user and affecting the user experience when wearing the head-mounted device.

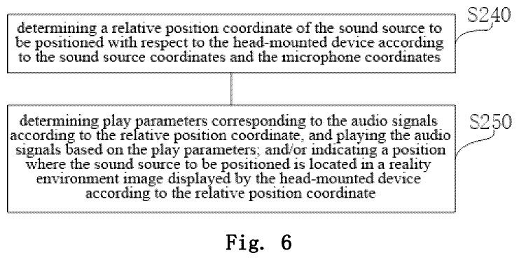

After obtaining the first calibration time differences between the first calibration receiving time points and the device coordinates of each of the loudspeakers, the microphone coordinate of each of the loudspeakers in the space coordinate system can be calculated based on the calculation principle of the sound source coordinate of the sound source in the space coordinate system. As illustrated in FIGS. 5, S1 to S4 represent four loudspeakers. The device coordinates of S1-S4 are known and are represented as S1=(a1, b1, c1), S2=(a2, b2, c2), S3=(a3, b3, c3), and S4=(a4, b4, c4). MIC1 to MIC4 represent four microphones disposed on the head-mounted device, and the microphone coordinates of MIC1 to MIC4 are unknown and are represented as M1=(i1, j1, k1), M2=(i2, j2, k2), M3=(i3, j3, k3), and M4=(i4, j4, k4). The step of determining the microphone coordinates according to the first calibration time differences and the device coordinates includes: setting a minimum flying time in which the first calibration audio signal reaches one of the microphones; constructing equations according to a sound transmission speed, the minimum flying time, the device coordinates and the first calibration time differences; and determining the microphone coordinates according to solution results of the equations. Assuming that the flying time for the first calibration audio signal to reach any one of MIC1-MIC4 is the minimum flying time. For example, the flying time for the first calibration audio signal to reach MIC1 is the minimum flying time, then equations for calculating the microphone coordinate of MIC1 is constructed as follows:

$$( Vair * T 1 min ) 2 = ( a 1 - i 1 ) 2 + ( b 1 - j 1 ) 2 + ( c 1 - c 1 ) 2 ;$$

$$( Vair * ( T 1 min + Δ t 12 ) ) 2 = ( a 2 - i 1 ) 2 + ( b 2 - j 1 ) 2 + ( c 2 - c 1 ) 2 ;$$

$$( Vair * ( T 1 min + Δ t 13 ) ) 2 = ( a 3 - i 1 ) 2 + ( b 3 - j 1 ) 2 + ( c 3 - c 1 ) 2 ;$$

$$( Vair * ( T 1 min + Δ t 14 ) ) 2 = ( a 4 - i 1 ) 2 + ( b 4 - j 1 ) 2 + ( c 4 - c 1 ) 2.$$

Here, Vair represents the sound transmission speed, T1 min represents the minimum flying time, Δt12 represents a time difference between the receiving time point of the first calibration audio signal received by MIC2 and the receiving time point of the first calibration audio signal received by MIC1, Δt13 represents a time difference between the receiving time point of the first calibration audio signal received by MIC3 and the receiving time point of the first calibration audio signal received by MIC1, and Δt14 represents a time difference between the receiving time point of the first calibration audio signal received by MIC4 and the receiving time point of the first calibration audio signal received by MIC1.

After constructing equations for calculating the microphone coordinate of MIC1, T1 min, i1, j1 and k1, that is, the microphone coordinate M1 of MIC1, is obtained by solving the equations. In addition, the method of calculating the microphone coordinates of MIC2-MIC4 is the same as the method of calculating the microphone coordinate of MIC1, which will not be repeated here. The microphone coordinates of MIC1-MIC4 can be calculated by the above calculation method.

Optionally, the step of determining the device coordinates of the loudspeakers respectively includes:
establishing the space coordinate system based on the microphones, and obtaining initial microphone coordinates of the microphones in the space coordinate system respectively;
controlling the loudspeakers to emit second calibration audio signals respectively, and determining second calibration time differences between second calibration receiving time points at which the microphones receive the second calibration audio signals respectively; and
determining the device coordinates of the loudspeakers respectively according to the second calibration time differences and the initial microphone coordinates.

Specifically, the space coordinate system is constructed with a center of setting position of each of the microphones as the origin, that is, the initial microphone coordinate of each microphone in the space coordinate system is known and can be obtained. The loudspeakers are controlled to emit sound signals of different frequencies form others, here, the sound signal is represented as a second calibration audio signal, and after the microphones receive the sound signals of different frequencies emitted by the loudspeaker respectively, second calibration receiving time points at which the microphones receive the second calibration audio signal respectively can be obtained, and accordingly, based on the second calibration receiving time points, second calibration time differences between the second calibration receiving time points can be calculated. Here, the purpose of controlling the loudspeakers to emit sound signals of different frequencies is to distinguish which loudspeaker emits the corresponding second calibration audio signal through the frequency of the second calibration audio signal, and the frequency of the second calibration audio signal is a sound frequency outside the audible range of the human ear, that is, when the user uses the head-mounted device, he or she cannot hear the sound emitted by the loudspeaker, which can avoid causing noise to the user and affecting the user experience when wearing the head-mounted device.

After obtaining the second calibration time differences and the initial microphone coordinates, the device coordinate of each of the loudspeakers can be calculated according to the above method for calculating the microphone coordinates. That is, the step of determining the device coordinate of each of the loudspeakers according to the second calibration time differences and the initial microphone coordinates includes: setting a minimum flying time in which the second calibration audio signal reaches one of the microphones; constructing equations according to a sound transmission speed, the minimum flying time, the initial microphone coordinates and the second calibration time differences; and determining the device coordinate of each of the loudspeakers according to solution results of the equations.

Assuming that the flying time for the second calibration audio signal to reach any one of MIC1-MIC4 is the minimum flying time. For example, the flying time for the second calibration audio signal to reach MIC1 is the minimum flying time. The device coordinates of S1-S4 are unknown and are represented as S′1=(a′1, b′1, c′1), S′2=(a′2, b′2, c′2), S′3=(a′3, b′3, c′3), S′4=(a′4, b′4, c′4). MIC1 to MIC4 represent four microphones disposed on the head-mounted device, and the initial microphone coordinates of MIC1 to MIC4 are known and are represented as M′1=(i′1, j′1, k′1), M′2=(i′2, j′2, k′2), M′3=(i′3, j′3, k′3), M′4=(i′4, j′4, k′4).

Equations for calculating the device coordinate S′1 of S1 is constructed as follows:

$$( Vair * T {1}^{′} min ) 2 = ( {i}^{′} 1 - {a}^{′} 1 ) 2 + ( {j}^{′} 1 - {b}^{′} 1 ) 2 + ( , {k}^{′} 1 - {c}^{′} 1 ) 2 ;$$

$$( Vair * ( T {1}^{′} min + {Δ}^{′} t 12 ) ) 2 = ( {i}^{′} 2 - {a}^{′} 1 ) 2 + ( {j}^{′} 2 - {b}^{′} 1 ) 2 + ( , {k}^{′} 2 - {c}^{′} 1 ) 2 ;$$

$$( Vair * ( T {1}^{′} min + {Δ}^{′} t 13 ) ) 2 = ( {i}^{′} 3 - {a}^{′} 1 ) 2 + ( {j}^{′} 3 - {b}^{′} 1 ) 2 + ( , {k}^{′} 3 - {c}^{′} 1 ) 2 ;$$

$$( Vair * ( T {1}^{′} min + {Δ}^{′} t 14 ) ) 2 = ( {i}^{′} 4 - {a}^{′} 1 ) 2 + ( {j}^{′} 4 - {b}^{′} 1 ) 2 + ( , {k}^{′} 4 - {c}^{′} 1 ) 2.$$

Here, Vair represents the sound transmission speed, T1′min represents the minimum flying time, Δ′t12 represents a time difference between the receiving time point of the second calibration audio signal received by MIC2 and the receiving time point of the second calibration audio signal received by MIC1, Δ′t13 represents a time difference between the receiving time point of the second calibration audio signal received by MIC3 and the receiving time point of the second calibration audio signal received by MIC1, and Δ′t14 represents a time difference between the receiving time point of the second calibration audio signal received by MIC4 and the receiving time point of the second calibration audio signal received by MIC1.

After constructing equations for calculating the device coordinate S′1 of S1, T′min, a′1, b′1 and c′1, that is, the device coordinate S′1 of S1, is obtained by solving the equations. In addition, the method of calculating the device coordinates of S2-S4 is the same as the method of calculating the device coordinate of S1, which will not be repeated here. The device coordinates of S1-S4 can be calculated by the above calculation method.

Optionally, the step of controlling each of the loudspeakers to emit a first calibration audio signal includes:
establishing a motion coordinate system based on a center of the head-mounted device; and
controlling a loudspeaker located on a coordinate axis of the motion coordinate system and a loudspeaker located outside a coordinate axis plane to emit the first calibration audio signals.

After obtaining the device coordinates of S1-S4, the microphone coordinates of the four microphones on the head-mounted device are calculated using the known device coordinates of S1-S4. A motion coordinate system oxyz is constructed with a center of the head-mounted device as the origin, so that any three loudspeakers of S1-S4 are located on the x-axis, y-axis, and z-axis of the motion coordinate system oxyz, and the remaining loudspeaker is located outside the coordinate axis plane. As illustrated in FIGS. 5, S1, S2, and S3 are located on the x-axis, y-axis, and z-axis, respectively, and S4 is located outside the oxy plane. Distances between S1-S4 and the origin 0 are known, S1-S4 are controlled to emit first calibration audio signals at different frequencies, and then the microphone coordinates of MIC1-MIC4 are calculated.

Optionally, the preset sound source device includes at least one loudspeaker disposed on the head-mounted device. Since the loudspeaker and microphones are disposed on the head-mounted device, the geometric position relationship such as the distance between each loudspeaker and the microphone, the direction of the microphone relative to the loudspeaker, etc. is fixed and is known data. The Step S210 further includes the following steps:
establishing the space coordinate system based on the microphones, and obtaining initial microphone coordinates of the microphones in the space coordinate system respectively;
controlling the loudspeaker to emit a third calibration audio signal, and determining third calibration time differences between third calibration receiving time points at which the microphones receive the third calibration audio signal;
determining a device coordinate of the loudspeaker according to the third calibration time differences and the initial microphone coordinates; and
obtaining a geometric position relationship between the loudspeaker and each of the microphones on the head-mounted device, and determining the microphone coordinates according to the device coordinate and the geometric position relationship.

Specifically, the space coordinate system is constructed with a center of setting position of each of the microphones as the origin, that is, the initial microphone coordinate of each microphone in the space coordinate system is known and can be obtained. The loudspeakers are controlled to emit sound signals, here, the sound signal is represented as a third calibration audio signal, and after the microphones receive the sound signals emitted by the loudspeakers respectively, third calibration receiving time points at which the microphones receive the third calibration audio signal respectively can be obtained, and accordingly, based on the third calibration receiving time points, third calibration time differences between the third calibration receiving time points can be calculated. Here, the frequency of the third calibration audio signal is a sound frequency outside the audible range of the human ear, that is, when the user uses the head-mounted device, he or she cannot hear the sound emitted by the loudspeaker, which can avoid causing noise to the user and affecting the user experience when wearing the head-mounted device.

After obtaining the third calibration time differences and the initial microphone coordinates, the device coordinate of the loudspeaker can be calculated according to the above method for calculating S′1, the calculation method of the device coordinate of the loudspeaker is the same as that of S′1, which will not be repeated here. After obtaining the device coordinate of the loudspeaker, the geometric position relationship between the loudspeaker and each of the microphones on the head-mounted device is obtained, wherein the geometric position relationship includes the distance between the loudspeaker and the microphones, the direction of the microphones relative to the loudspeaker, etc. Then, the microphone coordinate of each of the microphones is calculated by using the device coordinate of the loudspeaker and the geometric position relationship between the loudspeaker and each of the microphones.

Optionally, the preset sound source device includes at least four loudspeakers with device coordinates which are known previously, that is, the positions of the four loudspeakers are always fixed, which means that the device coordinates of the four loudspeakers are pre-calibrated and are known data. The Step S210 further includes the following steps:
obtaining device coordinates of the loudspeakers respectively;
controlling the loudspeakers to emit calibration audio signals respectively;
determining calibration time differences between calibration receiving time points at which the microphones receive the calibration audio signals respectively; and
determining the microphone coordinates according to the calibration time differences and the device coordinates.

Specifically, device coordinates of the loudspeakers are acquired respectively to obtain known data, and then the loudspeakers are controlled to emit calibration audio signals of different frequencies respectively. Controlling the loudspeakers to emit calibration audio signals of different frequencies respectively can distinguish which loudspeaker emits the calibration audio signal, and the calibration audio signal emitted by each loudspeaker is inaudible to the human ear. Then, calibration receiving time points at which the microphones receive the calibration audio signals respectively are obtained, and based on the calibration receiving time points at which the microphones receive the calibration audio signals respectively, the calibration time differences of the calibration receiving time points at which the microphones receive the calibration audio signals respectively can be calculated, and then the microphone coordinates are calculated according to the calibration time differences and the device coordinates. Here, the method of calculating the microphone coordinates according to the calibration time differences and the device coordinates is the same as the method of calculating MIC1 (x1, y1, z1), MIC2 (x2, y2, z2), MIC3 (x3, y3, z3), and MIC4 (x4, y4, z4), it is also necessary to construct a group of equations containing at least four variables, and the microphone coordinates of the microphones can be obtained by solving the group of equations. The construction and solution of the specific equations will not be repeated here.

Optionally, as illustrated in FIG. 6, the following steps are further included after the Step S230:

S240: determining, a relative position coordinate of the sound source to be positioned with respect to the head-mounted device according to the sound source coordinates and the microphone coordinates;

S250: determining play parameters corresponding to the audio signals according to the relative position coordinate, and playing the audio signals based on the play parameters; and/or indicating a position where the sound source to be positioned is located in a reality environment image displayed by the head-mounted device according to the relative position coordinate.

The purpose of establishing the space coordinate system is to allow the head-mounted device and the sound source to be positioned to have an absolute reference position, so that when the head-mounted device moves and the position of the sound source to be positioned changes, there is an absolute reference point. After calculating the sound source coordinate of the sound source to be positioned in the space coordinate system and the microphone coordinate of each microphone, since each microphone is disposed on the head-mounted device, the position of the head-mounted device in the space coordinate system can be determined according to the microphone coordinate of each microphone. Furthermore, since the user and the sound source to be positioned are relative to each other in the reality space environment, the user can hear the audio signal from the sound source to be positioned, and in order to make the user feel that the orientation of the audio signal heard when wearing the head-mounted device is the same as that in the reality space environment, the sound source coordinate and the microphone coordinates are used to calculate relative position coordinate of the sound source to be positioned relative to the head-mounted device, and then the play parameters of the audio signals are obtained according to the relative position coordinate, wherein the play parameters include orientation, frequency, loudness, etc. of the audio signal. Then, based on a sound following head movement technology, the head-mounted device is controlled to play the audio signal according to the play parameters. When the user uses the head-mounted device to view the displayed real-world environment images, the sound heard is in the same orientation as the sound heard when the user is not wearing the head-mounted device in the reality space environment. In other words, the orientation of the sound heard by the user wearing the virtual reality device is the same as the orientation of the sound heard in the reality world without wearing the head-mounted device.

In addition, after a camera on the head-mounted device captures a real-time image of the environment, the image undergoes a series of processing and the reality environment image is displayed on a display of the head-mounted device. This process allows the user using the head-mounted device to see the same information about the reality space environment as that when the head-mounted device is taken off. When the head-mounted device presents the reality environment image to the user, the position of the sound source to be positioned is indicated in the reality environment image displayed by the head-mounted device, and the sound source to be positioned is presented, so that the user can clearly see the position of the sound source to be positioned indicated in the reality environment image, that is, the specific position from which the sound is emitted, and the indicated position displays an identifier for playing the sound. When the user wears and uses the head-mounted device, he or she can feel the actual source of the sound through the head-mounted device without taking off the head-mounted device. That is, by wearing the head-mounted device, he or she can clearly know the specific position of the sound source in the reality space environment, thereby realizing the experience of sound perception of the real world in a virtual world, greatly enhancing the human-computer interaction experience. It should be noted that when the user wears the head-mounted device, the head-mounted device can play the audio signal of the sound source, and at the same time, can indicate the position of the sound source in the displayed reality environment image; or, when the user wears the head-mounted device, the head-mounted device plays the audio signal of the sound source; or, when the user wears the head-mounted device, the head-mounted device indicates the position of the sound source in the displayed reality environment image.

Furthermore, the present disclosure also provides a head-mounted device, which includes: a memory, a processor, and a sound source position determination program stored in the memory and executable on the processor, wherein the sound source position determination program, when executed by the processor, implements steps of the above-mentioned sound source position determination method.

Furthermore, the present disclosure also provides a storage medium, on which a sound source position determination program is stored, wherein when the sound source position determination program is executed by a processor, steps of the above-mentioned sound source position determination method are implemented.

Those skilled in the art should understand that the embodiments of the present disclosure may be provided as methods, systems, or computer program products. Therefore, the present disclosure may take the form of an entirely hardware embodiment, an entirely software embodiment, or an embodiment combining software and hardware aspects. Moreover, the present disclosure may take the form of a computer program product implemented on one or more computer-usable storage media (including but not limited to disk storage, CD-ROM, optical storage, etc.) containing computer-usable program codes.

The present disclosure is described with reference to flowcharts and/or block diagrams of methods, devices (systems), and computer program products according to embodiments of the present disclosure. It should be understood that each process and/or block in the flowchart and/or block diagram, and a combination of the processes and/or blocks in the flowchart and/or block diagram can be implemented by computer program instructions. These computer program instructions can be provided to a processor of a general-purpose computer, a special-purpose computer, an embedded processor or other programmable data processing devices to produce a machine, so that the instructions executed by the processor of the computer or other programmable data processing devices produce a device for implementing the functions specified in one or more processes in the flowchart and/or one or more blocks in the block diagram.

These computer program instructions may also be stored in a computer-readable memory that can direct a computer or other programmable data processing devices to work in a specific manner, so that the instructions stored in the computer-readable memory produce a manufactured product including an instruction device that implements the functions specified in one or more processes in the flowchart and/or one or more blocks in the block diagram.

These computer program instructions may also be loaded onto a computer or other programmable data processing devices so that a series of operations or steps are performed on the computer or other programmable devices to produce a computer-implemented process, whereby the instructions executed on the computer or other programmable devices provide steps for implementing the functions specified in one or more processes in the flowchart and/or one or more blocks in the block diagram.

It should be noted that, in the claims, any reference signs placed between parentheses shall not be constructed as limiting a claim. The word “comprise” does not exclude the presence of elements or steps not listed in a claim. The word “a” or “an” preceding an element does not exclude the presence of a plurality of such elements. The present application can be implemented by means of hardware including several distinct elements, and by means of a suitably programmed computer. In a unit claim enumerating several means, several of these means may be embodied by the same hardware item. The usage of the words “first”, “second”, “third”, etc. does not indicate any order, and these words can be interpreted as names.

Although preferred embodiments of the present disclosure have been described, additional changes and modifications may be made to these embodiments once those skilled in the art are aware of the basic inventive concepts. Therefore, it is intended that the appended claims be interpreted as including the preferred embodiment as well as all changes and modifications that fall within the scope of the present disclosure.

Obviously, those skilled in the art can make various modifications and variations to the present disclosure without departing from the spirit and scope of the disclosure. Thus, if these modifications and variations of the present disclosure fall within the scope of the claims of the present disclosure and their equivalent technologies, the present application is also intended to include these modifications and variations.

1. A sound source position determination method, which is applied to a head-mounted device, wherein the head-mounted device comprises at least four microphones, and the sound source position determination method comprises:
determining microphone coordinates of the microphones in a space coordinate system according to a device coordinate of a preset sound source device, wherein the space coordinate system is established in a space where the head-mounted device is located;
determining time differences between receiving time points at which the microphones receive audio signals sent by a sound source to be positioned; and
determining a sound source coordinate of the sound source to be positioned in the space coordinate system according to the microphone coordinates and the time differences.

2. The method of claim 1, wherein the preset sound source device comprises at least four loudspeakers disposed on the head-mounted device, and the determining the microphone coordinates of the microphones in the space coordinate system according to the device coordinate of the preset sound source device comprises:
determining device coordinates of the loudspeakers respectively;
controlling the loudspeakers to emit first calibration audio signals respectively;
determining first calibration time differences between first calibration receiving time points at which the microphones receive the first calibration audio signals respectively; and
determining the microphone coordinates according to the first calibration time differences and the device coordinates.

3. The method of claim 2, wherein the determining the device coordinates of the loudspeakers respectively comprises:
establishing the space coordinate system based on the microphones, and obtaining initial microphone coordinates of the microphones in the space coordinate system respectively;
controlling the loudspeakers to emit second calibration audio signals respectively, and determining second calibration time differences between second calibration receiving time points at which the microphones receive the second calibration audio signals respectively; and
determining the device coordinates of the loudspeakers respectively according to the second calibration time differences and the initial microphone coordinates.

4. The method of claim 2, wherein the controlling the loudspeakers to emit the first calibration audio signal respectively comprises:
establishing a motion coordinate system based on a center of the head-mounted device; and
controlling a loudspeaker located on a coordinate axis of the motion coordinate system and a loudspeaker located outside a coordinate axis plane to emit the first calibration audio signals.

5. The method of claim 1, wherein the determining the sound source coordinate of the sound source to be positioned in the space coordinate system according to the microphone coordinates and the time differences comprises:
setting a minimum flying time in which the audio signals reach one of the microphones;
constructing equations according to a sound transmission speed, the minimum flying time, the microphone coordinates and the time differences; and
determining the sound source coordinate of the sound source to be positioned in the space coordinate system according to solution results of the equations.

6. The method of claim 1, further comprising: after the determining the sound source coordinate of the sound source to be positioned in the space coordinate system according to the microphone coordinates and the time differences,
determining a relative position coordinate of the sound source to be positioned with respect to the head-mounted device according to the sound source coordinate and the microphone coordinates;
determining play parameters corresponding to the audio signals according to the relative position coordinate, and playing the audio signals based on the play parameters; and/or
indicating a position where the sound source to be positioned is located in a reality environment image displayed by the head-mounted device according to the relative position coordinate.

7. The method of claim 1, wherein the preset sound source device comprises at least one loudspeaker disposed on the head-mounted device, and the determining the microphone coordinates of the microphones in the space coordinate system according to the device coordinate of the preset sound source device further comprises:
establishing the space coordinate system based on the microphones, and obtaining initial microphone coordinates of the microphones in the space coordinate system respectively;
controlling the loudspeaker to emit a third calibration audio signal, and determining third calibration time differences between third calibration receiving time points at which the microphones receive the third calibration audio signal;
determining a device coordinate of the loudspeaker according to the third calibration time differences and the initial microphone coordinates; and
obtaining a geometric position relationship between the loudspeaker and each of the microphones on the head-mounted device, and determining the microphone coordinates according to the device coordinate and the geometric position relationship.

8. The method of claim 1, wherein the preset sound source device comprises at least four loudspeakers with device coordinates which are known previously, and the determining the microphone coordinates of the microphones in the space coordinate system according to the device coordinate of the preset sound source device further comprises:
obtaining device coordinates of the loudspeakers respectively;
controlling the loudspeakers to emit calibration audio signals respectively;
determining calibration time differences between calibration receiving time points at which the microphones receive the calibration audio signals respectively; and
determining the microphone coordinates according to the calibration time differences and the device coordinates.

9. A head-mounted device, comprising: a memory, a processor, and a sound source position determination program stored in the memory and executable on the processor,
wherein the sound source position determination program, when executed by the processor, implements steps of the sound source position determination method of claim 1.

10. A non-transitory storage medium, on which a sound source position determination program is stored, wherein when the sound source position determination program is executed by a processor, steps of the sound source position determination method of claim 1 are implemented.
